(19) United States
(12) Patent Application Publication
(10) Pub. No.: US 2008/0063766 A1
(43) Pub. Date: Mar. 13, 2008

(54) PROCESS TO IMPROVE THE TASTE AND EXTEND THE SHELF-LIFE OF SOYBEANS AND PRODUCTS DERIVED THEREFROM

(75) Inventor: Billy M. Groves, Rogers, AR (US)

Correspondence Address: WINSTEAD PC, P.O. BOX 50784, DALLAS, TX, 75201, US

(73) Assignee: Grovac Southern Select, L.C., Rogers, AR (US)

(21) Appl. No.: 11/737,848

(22) Filed: Apr. 20, 2007

Related U.S. Application Data
(60) Provisional application No. 60/844,223, filed on Sep. 13, 2006.

(51) Int. Cl. A23J 3/16; A23L 1/00

(52) U.S. Cl. 426/331; 426/601; 426/634

(57) ABSTRACT

A method of processing soy beans includes providing soy beans in a vacuum tumbler equipped with lifting ribs and tumbling the soy beans in an alternating environment of a vacuum and an acidic solution. Afterwards, at least a portion of the moisture is removed from the soy beans. A soy bean product made from soy beans so process is substantially free of trans fats and has an Iodine Value in a range from x to y. The process improves the taste and extends the shelf life of soy beans

### RELATED APPLICATIONS

This application claims priority to provisional application 60/844,223 filed Sep. 13, 2006 and is incorporated by reference herein in its entirety.

### FIELD OF THE INVENTION

The present invention relates in general to a process for improving the taste and shelf life of soybeans and soybean products.

### BACKGROUND

The nutritional benefits of soy are significant and well-established. Soybeans derive 35 to 38 percent of their calories from protein compared to approximately 20 to 30 percent in other legumes and much less in cereals and grains. Soy protein is of the highest quality. Under new guidelines adopted by the Food and Drug Administration and the World Health Organization for evaluating protein quality for children and adults, soy protein isolate receives a rating of 1, which is the highest possible score. This means that the quality of soy protein is equal to that of meat and milk proteins yet, since it comes from a plant, it is both more environmentally friendly to produce and easier to process and transport than animal-based protein. Vegetable proteins also have the advantage of causing less calcium loss through the kidneys.

By adding soy flour to wheat, the protein content of bread can be increased three to five times. This makes the bread much healthier for diabetics, for example, who tolerate protein much better than carbohydrates.

About 40% of the calories from soybeans come from fat. Most of the fat in soybeans is unsaturated. Polyunsaturated (primarily linoleic acid), monounsaturated (oleic acid) and saturated (primarily palmitic acid) fats make up 54 percent, 23 percent, and 16 percent respectively of the fat in soybeans. The polyunsaturated fat content of soybeans is of interest because it includes linolenic acid (seven percent of the total fat content), an omega-3 fatty acid. Soybeans are one of the few plant sources of omega-3 fatty acids. Omega-3 fatty acids may be essential nutrients for infants and they may also help to reduce risk of both heart disease and cancer.

Soy also contains high concentrations of isoflavones which have many health benefits including reduction of cholesterol, easing of menopause symptoms, prevention of osteoporosis and reduction of risk for certain cancers (prostate cancer and breast cancer). Isoflavones are antioxidants which protect our cells and DNA against oxidation. Soybeans, like other whole, unprocessed plant foods, contain dietary fiber. One serving of soybeans provides approximately eight grams of dietary fiber. About 30 percent of the fiber in soyfoods is soluble fiber. Finally, soybeans are also rich in calcium, iron, zinc and B vitamins, and oil soluble vitamins such as vitamin E.

Because they are a plant, soybeans can be processed into a variety of forms that are easily transportable and storable, with extended shelf life, without the refrigeration and other costs associated with transporting and storing meat and dairy products.

Despite all the health benefits afforded by soybeans, they have suffered from an offensive taste that has greatly diminished their appeal as a human food source. In order to derive some of the nutritional benefits from soy while eliminating this taste, industry has developed methods of creating soy-based protein isolates and concentrates that are very expensive and also have resulted in diminished nutritional value of the soybean by, for example, reducing its fat content and the amount of vitamins and minerals present.

Moreover, oil derived from soybeans typically undergoes hydrogenation a process that extends its shelf-life by delaying the onset of oxidative decay and rancidity. Hydrogenation involves exposing soybean oil to heat and pressure in the presence of certain metals and hydrogen. Not only is the process costly in time and energy, but also trans fatty acids, an extremely undesirable byproduct of hydrogenation, is created. Trans fatty acids have been determined to contribute significantly to heart disease. The FDA last year issued regulations requiring that foods containing more than 0.5 grams of trans fat be so labeled, and many jurisdictions, including major American cities, are imposing regulations that severely restrict the serving of foods containing trans fats in restaurants.

Therefore, it is a desire to provide a process that reduces the bad taste and increase the shelf life of soybeans and products made therefrom, without compromising the nutritional value of the soy. Furthermore, such processing should avoid the formation of harmful trans fatty acids. Finally, the process should be energy efficient and not use elevated temperatures and the requisite large energy consumption associated with such processes.

### SUMMARY OF THE INVENTION

In view of the foregoing and other considerations, the present invention relates to processing soy beans for consumption and/or use of the soy beans and products derived therefrom. Accordingly, a method of processing soy beans includes providing soy beans in a vacuum tumbler equipped with lifting ribs and tumbling the soy beans in an alternating environment of a vacuum and an acidic solution. The soy beans are removed from the tumbler and a portion of moisture is removed from the soy beans. A soy bean product made by this process is substantially free of trans fatty acids and has an Iodine Value in a range from 90 to 120. The process improves the taste and extends the shelf life of soy beans.

The foregoing has outlined the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is a block diagram showing the processing of soy beans in accordance with embodiments of the present invention.

### DETAILED DESCRIPTION

The present invention provides a process for improving the taste and extending the shelf-life of soybeans and products made therefrom, including, but not limited to soybean oil and soy protein isolates. The process generally involves providing soy beans in a vacuum tumbler equipped with lifting ribs and tumbling the soy beans in an alternating environment of a vacuum and an acidic solution. Specifically, the process of the present invention calls for the vacuum tumbling for a set period of time in an acidic solution with a pH lower than 7.0 of de-hulled soybeans. As a consequence of the process, the offensive “beany” taste is eliminated and the soy beans and products derived therefrom (oil, flour, etc.) are palatable to humans. Once this is complete the soy beans are removed from the vacuum tumbler and at least a portion of the moisture is removed from the soy beans. The amount of moisture removed should be enough to allow further processing of the soy beans into flake, flour, or meal form.

As used herein, the vacuum tumbling process involves mechanically tumbling soybeans in a tumbler device, massager and/or chamber. Vacuum tumbling may enhance cleaning and expose greater cellular membrane areas to the process, through mechanical stresses. The mechanical stresses of vacuum tumbling may also contribute to bacterial lysis, which improves the shelf life of the soy beans. With this in mind, the tumbling speed may range from about 2 to about 14 rpm. In a typical run the vacuum tumbling may be conducted at about 8 rpm.

Typical vacuum tumblers are designed for marinating food products. Marinating equipment, therefore, usually does not incorporate ribs to carry product out of the solution, rather, the shear movement of the drum carries the product to about the 4 o'clock position, sometimes not even moving the entire product out of the solution, and then by the nature of gravity is “dropped” back into the solution.

In the present invention, the vacuum tumbler is equipped with special ribs that have been designed to lift the product completely out of an acidic solution, to about the 1-2 o'clock position before a free fall back into the solution. This allows the product to have much more exposure to the vacuum environment.

Finally, other conditions for the vacuum tumbling process include having a temperature ranging from about 0.5° C. to about 27° C. Although the available range for conducting the process is fairly broad, generally the soy beans are processed near ambient temperatures. This is in stark contrast to the high temperatures required by typical soy bean refining processes. Thus, the immediate benefit of the present invention is a process that is less energy intensive.

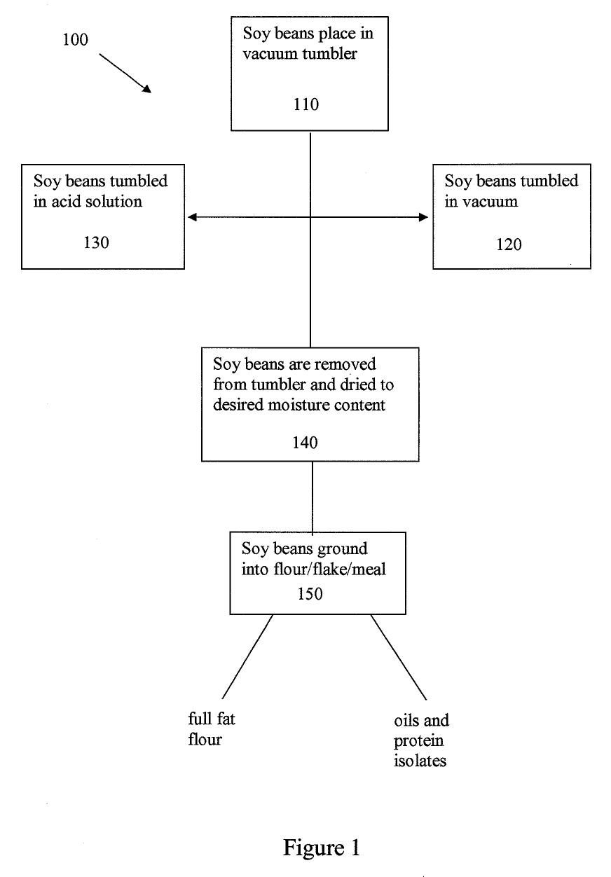

Referring now to FIG. 1, the process 100 begins by placing soy beans in a vacuum tumber, at step 110. The soy beans are then tumbled in an alternating environment of a vacuum step 120 and an acidic solution step 130. The soy beans are cycled through the vacuum and acidic solution in 4-20 minute intervals. During the vacuum cycle, the vacuum may be in a range from about 15 to about 28 inches of mercury. Such low vacuums can be obtained, for example, by water aspiration. The soy beans are removed and then a sufficient amount of water is removed at step 140 to allow grinding them into flour, flake, or meal at step 150. Processing beyond this point to generate soy bean protein isolates or oils are performed under standard conditions performed in a typical soy mill.

Various chemical aspects of the present invention also enhance the quality and flavor of the food products and improve their shelf life. The acidic solution may have a pH ranging from about 2.4 to about 6.5. The process allows for a fairly broad range of pH with the best results being obtained by having a pH less than 7. The acidic solution may be composed of an aqueous solution of an organic acid. More specifically, the organic acid should be an organic acid suitable for food use if the end product soy bean is to be used for human or animal consumption. Examples of such organic acids include, but are not limited to citric acid, ascorbic acid, lactic acid, tartaric acid, acetic acid and benzoic acid.

The soy beans that are produced by this process may be used in the formation of a soy bean product such as a flour, a flake, and a meal. Typically, after grinding the soy beans may be processed by conventional methods into soy protein isolates or the oils may be extracted for both food consumption and for biodiesel fuel processing.

An important aspect of the processing results in soy beans and thence soy bean products having Iodine Values lower than those obtained by existing industry standards. Iodine value (IV) is a measure of the total number of double bonds present in fats and oils. It is generally expressed in terms of the number of grams of iodine that will react with the double bonds in 100 grams of fats or oils. A high IV oil contains a greater number of double bonds than a low IV oil. Edible oils with high iodine value are usually less stable and more susceptible to oxidation.

A soy bean product having an Iodine Value in a range from about 90 to 120, may be achieved by the process described above. Such soy bean products include the soy beans themselves, the soy bean oil extracts, as well as the soy protein isolates. The lower Iodine Value of soybean oil (typically around 108) makes it eligible as a feedstock for biodiesel in Europe, whereas regular refined soybean oil cannot so qualify because it has an Iodine Value in excess of 120, which is the maximum permitted by applicable EU regulations.

Soy beans processed as described may have improved taste and have extended shelf life. Of even greater interest, oil produced from these processed soy beans contains negligible amounts of trans fats (i.e. is substantially free of trans fats save those that are naturally occurring) and yet it has greater stability, longer shelf-life and less tendency to become rancid than unprocessed, unhydrogenated soybean oil. Therefore, the process presents a completely new, heretofore unknown method of stabilizing soybean oil, without creating unhealthy trans fats as a byproduct.

Advantageously, the vacuum tumbling process described herein also is non-thermal and therefore requires little energy expenditure, and the ingredients involved are innocuous, requiring no special handling, and are relatively inexpensive. Because the process works on the actual soybean, no special treatment or handling is required. The processed soybean remains “fresh” for an indefinite period of time if stored properly. Finally, the process is less expensive to perform than standard industry hydrogenation, and requires the consumption of materially less energy, since the process is non-thermal.

From the foregoing detailed description of specific embodiments of the invention, it should be apparent that a method for processing soy beans that is novel has been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

What is claimed is:

1. A method of processing soy beans comprising:
providing soy beans in a vacuum tumbler equipped with lifting ribs;
tumbling the soy beans in an alternating environment of a vacuum and an acidic solution; and
removing at least a portion of the moisture from the soy beans.

2. The method of claim 1, wherein the step of tumbling occurs in a temperature range from about 0.5° C. to about 27° C.

3. The method of claim 1, wherein the tumbling speed ranges from about 2 to about 14 rpm.

4. The method of claim 1, wherein the acidic solution has a pH ranging from about 2.4 to about 6.5.

5. The method of claim 1, wherein the acidic solution comprises and aqueous solution of an organic acid.

6. The method of claim 5, wherein the organic acid is selected from the group consisting of citric acid, ascorbic acid, lactic acid, tartaric acid, acetic acid and benzoic acid.

7. The method of claim 1, wherein the vacuum is in a range from about 15 to about 28 inches of mercury.

8. The method of claim 1, further comprising grinding the soy beans to provide a soy bean product selected from the group consisting of a flour, a flake, and a meal.

9. The method of claim 8, further comprising isolating soy bean oil from the soy bean product.

10. The method of claim 8, further comprising isolating soy bean protein isolates from the soy bean product.

11. A soy bean product substantially free of trans fats and having an Iodine Value in a range from 90 to 120.

12. The soy bean product of claim 11, wherein the soy bean product is selected from the group consisting of soy beans, soy bean oil, and soy bean protein isolates.

13. A method of improving taste and extending shelf life of soy beans comprising:
providing soy beans in a vacuum tumbler;
tumbling the soy beans in an alternating environment of a vacuum and an acidic solution; and
removing at least a portion of the moisture from the soy beans.

14. The method of claim 13, wherein the step of tumbling occurs in a temperature range from about 0.5° C. to about 27° C.

15. The method of claim 13, wherein a tumbling speed ranges from about 2 to about 14 rpm.

16. The method of claim 13, wherein the acidic solution has a pH ranging from about 2.4 to about 6.5.

17. The method of claim 13, wherein the acidic solution comprises and aqueous solution of an organic acid.

18 The method of claim 17, wherein the organic acid is selected from the group consisting of citric acid, ascorbic acid, lactic acid, tartaric acid, acetic acid and benzoic acid.

19. The method of claim 13, wherein the vacuum is in a range from about 15 to about 28 inches of mercury.
